(19) United States
(12) Patent Application Publication
(10) Pub. No.: US 2025/0212183 A1
(43) Pub. Date: Jun. 26, 2025

(54) Network Device and Method for Handling Downlink Multi-user Multiplexing for a Wireless Local Area Network

(71) Applicant: MEDIATEK INC., Hsin-Chu (TW)

(72) Inventors: Yan Shi, San Jose, CA (US); Yu-Hsien Chang, San Jose, CA (US)

(73) Assignee: MEDIATEK INC., Hsin-Chu (TW)

(21) Appl. No.: 18/823,703

(22) Filed: Sep. 4, 2024

Related U.S. Application Data
(60) Provisional application No. 63/614,683, filed on Dec. 26, 2023.

(51) Int. Cl. H04W 72/04; H04W 84/12

(52) U.S. Cl. CPC H04W 72/04; H04W 84/12

(57) ABSTRACT

A network device for handling downlink (DL) multi-user multiplexing for a wireless local area network (WLAN) comprises storage device(s) and processing circuit(s). The storage device(s) is configured to store instructions. The processing circuit(s) is configured to execute the instructions of: identifying a first traffic and a second traffic; in response to the first traffic being a normal traffic and the second traffic being a low latency traffic, performing a first correlation operation according to the first traffic and the second traffic, to generate a plurality of first correlation results; determining a first maximum correlation result and a first position index according to the plurality of first correlation results; and in response to the first maximum correlation result being greater than a first threshold, puncturing the first traffic with the second traffic according to the first maximum correlation result and the first position index.

### CROSS REFERENCE TO RELATED APPLICATIONS

This application claims the benefit of U.S. Provisional Application No. 63/614,683, filed on Dec. 26, 2023. The content of the application is incorporated herein by reference.

### BACKGROUND

With an increasing number of communication devices in a limited space (e.g., home, office, etc.), limited bandwidth resources becomes crowded. That is, a frequency spectrum usage is inefficient. Satisfying the services with different latency and throughput requirements simultaneously can be challenging for a wireless industry. Therefore, how to handle a downlink (DL) multi-user multiplexing for the communication devices in the limited space in order to save the resources and improve the spectrum efficiency is an important problem to be solved.

### SUMMARY

It is an objective of the invention to provide a network device and a method for handling downlink multi-user multiplexing for a WLAN (e.g., Wi-Fi), in order to solve the above problem.

An embodiment of the invention provides a network device for handling downlink (DL) multi-user multiplexing for a wireless local area network (WLAN) comprising at least one storage device and at least one processing circuit. The at least one storage device is configured to store instructions. The at least one processing circuit is coupled to the at least one storage device and configured to execute the instructions of: identifying a first traffic and a second traffic; in response to the first traffic being a normal traffic and the second traffic being a low latency traffic, performing a first correlation operation according to the first traffic and the second traffic, to generate a plurality of first correlation results; determining a first maximum correlation result and a first position index according to the plurality of first correlation results; and in response to the first maximum correlation result being greater than a first threshold, puncturing the first traffic with the second traffic according to the first maximum correlation result and the first position index.

An embodiment of the invention provides a method for handling downlink (DL) multi-user multiplexing for a wireless local area network (WLAN) comprising: identifying a first traffic and a second traffic; in response to the first traffic being a normal traffic and the second traffic being a low latency traffic, performing a first correlation operation according to the first traffic and the second traffic, to generate a plurality of first correlation results; determining a first maximum correlation result and a first position index according to the plurality of first correlation results; and in response to the first maximum correlation result being greater than a first threshold, puncturing the first traffic with the second traffic according to the first maximum correlation result and the first position index.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an embodiment of the invention.

FIG. 2 is a schematic diagram of a device according to an embodiment of the invention.

FIG. 3 is a flowchart of a process according to an embodiment of the invention.

FIG. 4 is a schematic diagram of a constellation according to an embodiment of the invention.

FIG. 5 is a schematic diagram of a normal puncturing mode according to an embodiment of the invention.

FIG. 6 is a schematic diagram of an urgent puncturing mode according to an embodiment of the invention.

FIGS. 7A and 7B are a flowchart of a process according to an embodiment of the invention.

FIG. 8 is a schematic diagram of a simulation result according to an embodiment of the invention.

FIG. 9 is a schematic diagram of a simulation result according to an embodiment of the invention.

FIG. 10 is a schematic diagram of a simulation result according to an embodiment of the invention.

FIG. 11 is a schematic diagram of a simulation result according to an embodiment of the invention.

FIG. 12 is a schematic diagram of a simulation result according to an embodiment of the invention.

FIG. 13 is a schematic diagram of a simulation result according to an embodiment of the invention.

### DETAILED DESCRIPTION

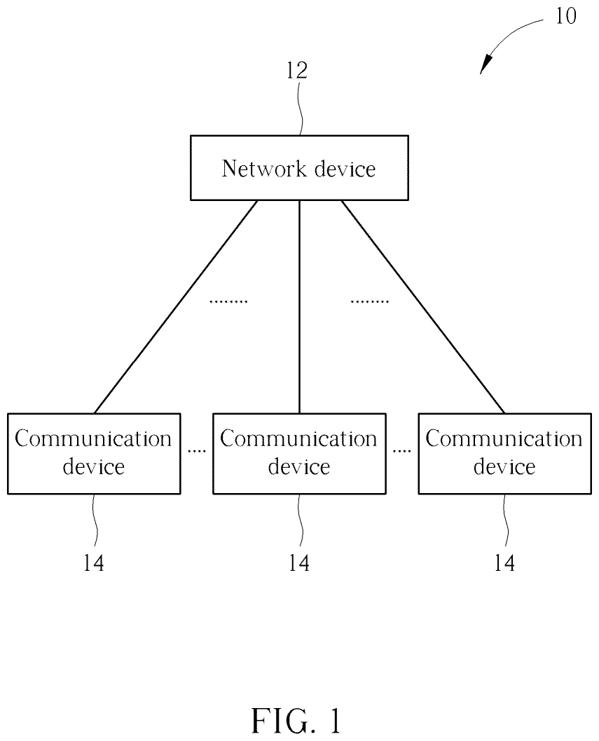

FIG. 1 is a schematic diagram of a wireless communication system 10 according to an embodiment of the invention. The wireless communication system 10 comprises a network device 12 and a plurality of communication devices 14. The wireless communication system 10 may be a wireless local area network (WLAN), a Long Term Evolution (LTE) system, a LTE-advanced (LTE-A) system or a 5th generation (5G) system, but is not limited herein. In some embodiments of the invention, the network device 12 is an access point (AP) in the WLAN. In some embodiments of the invention, a communication device 14 may be a station (STA), a user equipment (UE), a Very Small Aperture Terminal (VSAT), a low cost device (e.g., machine type communication (MTC) device), a device-to-device (D2D) communication device, an internet of things (IoT) device, a mobile phone, a laptop, a tablet computer, an electronic book, a portable computer system, or combination thereof.

The network device 12 and the communication devices 14 support an Institute of Electrical and Electronics Engineers (IEEE) 802.11 standard (e.g., IEEE 802.11ax, 802.11be or a subsequent version). The IEEE 802.11 standard supports an orthogonal frequency division multiple access (OFDMA) and/or a multi-user multiple-input multiple-output (MU-MIMO). In addition, the network device 12 and the communication device 14 can be seen as a transmitter or a receiver according to transmission direction. For an uplink (UL), the communication device 14 is the transmitter and the network device 12 is the receiver. For a downlink (DL), the network device 12 is the transmitter and the communication device 14 is the receiver.

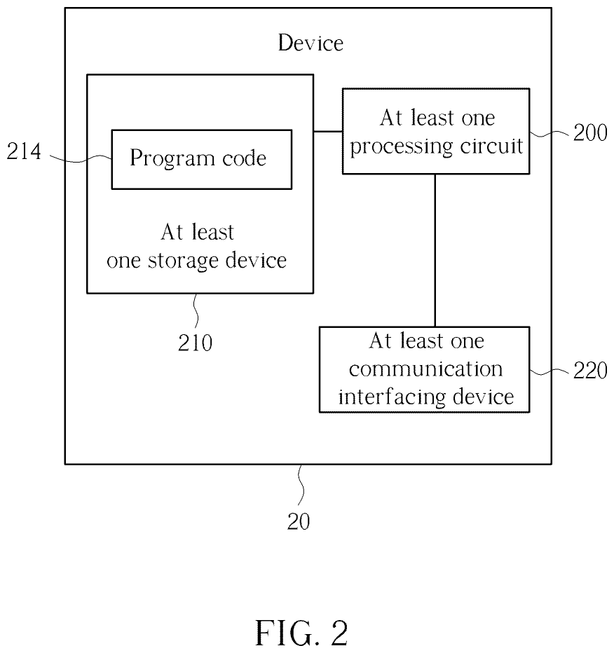

FIG. 2 is a schematic diagram of a device 20 according to an embodiment of the invention. The device 20 may be the network device 12 or a communication device 14 shown in FIG. 1, but is not limited herein. The device 20 may include at least one processing circuit 200 such as a microprocessor or Application Specific Integrated Circuit (ASIC), at least one storage device 210 and at least one communication interfacing device 220. The at least one storage device 210 may be any data storage device that may store program codes 214, accessed and executed by the at least one processing circuit 200. Examples of the at least one storage device 210 include, but are not limited to, a subscriber identity module (SIM), read-only memory (ROM), flash memory, random-access memory (RAM), Compact Disc Read-Only Memory (CD-ROM), digital versatile disc-ROM (DVD-ROM), Blu-ray Disc-ROM (BD-ROM), magnetic tape, hard disk, optical data storage device, non-volatile storage device, non-transitory computer-readable medium (e.g., tangible media), etc. The at least one communication interfacing device 220 is preferably at least one transceiver and is used to transmit and receive signals (e.g., data, messages and/or packets) according to processing results of the at least one processing circuit 200.

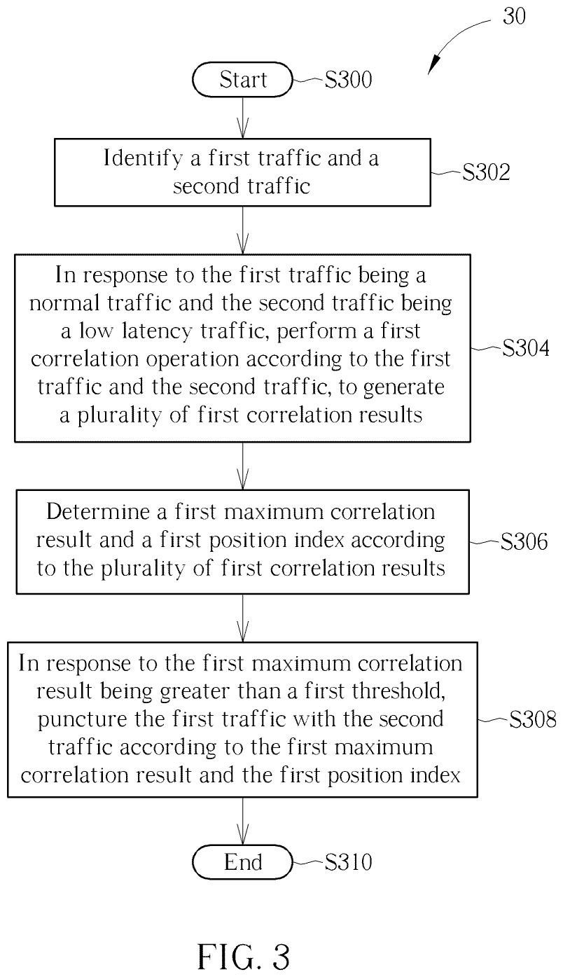

FIG. 3 is a flowchart of a process 30 according to an embodiment of the invention. The process 30 may be utilized in a network device (e.g., the network device 12 in FIG. 1 or the device in FIG. 2), to handle DL multi-user multiplexing for a WLAN. The process 30 may be compiled into the program codes 214 and comprises the following steps:
Step S300: Start.
Step S302: Identify a first traffic and a second traffic.
Step S304: In response to the first traffic being a normal traffic and the second traffic being a low latency traffic, perform a first correlation operation according to the first traffic and the second traffic, to generate a plurality of first correlation results.
Step S306: Determine a first maximum correlation result and a first position index according to the plurality of first correlation results.
Step S308: In response to the first maximum correlation result being greater than a first threshold, puncture the first traffic with the second traffic according to the first maximum correlation result and the first position index.
Step S310: End.

In the process 30, the punctured first traffic is generated in Step S308, and comprises partial information of the first traffic and the second traffic. The network device transmits the punctured first traffic instead of transmitting the first traffic and the second traffic. Therefore, resources (e.g., the time resource and/or the frequency resource) for transmission can be saved and the spectrum efficiency can be improved.

Realization of the process 30 is not limited to the above description. The following embodiments of the invention may be applied to realize the process 30.

In an embodiment of the invention, the first traffic corresponds to a first communication device, and the second traffic corresponds to a second communication device. In an embodiment of the invention, the network device transmits the punctured first traffic after puncturing the first traffic with the second traffic. A plurality of communication devices (e.g., the communication devices in FIG. 1 or the device in FIG. 2) receive the punctured first traffic, and decode the punctured first traffic to obtain the first traffic and/or the second traffic. For example, the first communication device decodes the punctured first traffic to obtain the first traffic. For example, the second communication device decodes the punctured first traffic to obtain the second traffic.

In an embodiment of the invention, the normal traffic is a relatively large size traffic, and is robust to bit errors or packet drops. The normal traffic may be a video streaming or a picture message, but is not limited herein. In an embodiment of the invention, the low latency traffic is a relatively small size traffic, and is sensitive to packet drops. The low latency traffic may be a gaming or a Voice over Internet Protocol (VOIP), but is not limited herein. That is, a size of the normal traffic (e.g., a data length of the normal traffic or a number of resource units (RUS) occupied by the normal traffic) is greater than a size of the low latency traffic (e.g., a data length of the low latency traffic or a number of RUs occupied by the low latency traffic). A data length which is usually in units of microsecond (ms) or number of orthogonal frequency division multiplexing (OFDM) symbols represents the time resources. The longer the data length, the higher the time resources usage. A RU which is usually in units of number of OFDM subcarriers represents the frequency resources. The greater the number of RUs, the higher the frequency resource usage.

In an embodiment of the invention, the first correlation operation is defined according to following equation:

$$R [ m ] = \frac{1}{p * {N}_{2}} {\sum }_{n = 0}^{{N}_{2} - 1} {T}_{1} [ n - m ] * {T}_{2} [ n ] , 0 \leq m \leq {N}_{1} - 1 \qquad ( 1 )$$

wherein R[m] is a first correlation result for m, m is a variable of a position index for the first traffic, p is a normalization factor, T₁[n] and T₂[n] are data of the first traffic and the second traffic, respectively, N₁ and N₂ are data lengths of the first traffic and the second traffic, respectively, and * is a conjugate operation. In an embodiment of the invention, the first maximum correlation result is a maximum of the plurality of first correlation results, and the first position index corresponds to the maximum of the plurality of first correlation results. In an embodiment of the invention, the normalization factor p is determined according to at least one of a first demodulation scheme of the first traffic and a second demodulation scheme of the second traffic.

In an embodiment of the invention, the Step S308 comprises: generating a weighted second traffic; and replacing a first part of the first traffic with the weighted second traffic. In an embodiment of the invention, a start of the first part of the first traffic is indicated by the first position index. That is, the weighted second traffic overwrites the first traffic starting from a position indicated by the first position index. In an embodiment of the invention, the step of generating the weighted second traffic comprises: in response to the first maximum correlation result being greater than a second threshold, configuring that the weighted second traffic is the same as the second traffic; and in response to the first maximum correlation result being greater than the first threshold and not greater than the second threshold, performing a first weighted operation on the second traffic with the first traffic according to the first maximum correlation result and the first position index.

In an embodiment of the invention, the second threshold is greater than the first threshold. It should be noted that 0≤the first threshold<the second threshold≤1. The maximum of the second threshold is determined as 1 in response to the normalization factor p. In an embodiment of the invention, the first threshold is a dynamic value, and the second threshold is a fixed value (e.g., 0.9).

In an embodiment of the invention, the first weighted operation is defined according to following equation:

$${T}_{2 , w} [ n ] = ( 1 - R [ \overline{m} ] ) {T}_{1} [ \overline{m} + n ] + R [ \overline{m} ] {T}_{2} [ n ] , 0 \leq n \leq {N}_{2} - 1 \qquad ( 2 )$$

wherein T_{2,w}[n] is the weighted second traffic, R[m̅] is the first maximum correlation result, m is the first position index, T₁[n] and T₂[n] are data of the first traffic and the second traffic, respectively, and N₂ is a data length of the second traffic.

In an embodiment of the invention, the network device adjusts the first threshold according to at least one of a channel quality, the first demodulation scheme of the first traffic and the second demodulation scheme of the second traffic. For example, the network device decreases the first threshold, when the channel quality is good (e.g., a channel quality indicator (such as a signal-to-noise ratio (SNR)) is greater than a channel quality threshold). For example, the network device increases the first threshold, when the channel quality is not good (e.g., the channel quality indicator (such as the SNR) is smaller than the channel quality threshold). For example, the first threshold T₁ is determined according to following equation:

$${T}_{1} = α {e}^{- \frac{SNR}{β ( mod )}} \qquad ( 3 )$$

wherein α is a constant scaling factor, SNR is a channel reported condition by ratio and is a common indicator in a wireless communication system (e.g., the wireless communication system 10 in FIG. 1), and β(mod) is a dynamic demodulation scheme scaling factor depending on at least one of the first demodulation scheme and the second demodulation scheme.

In an embodiment of the invention, the network device identifies a third traffic. Then, in response to the first traffic being the normal traffic and the third traffic being the low latency traffic, the network device performs a second correlation operation according to the first traffic and the third traffic, to generate a plurality of second correlation results. The network device determines a second maximum correlation result and a second position index according to the plurality of second correlation results. In response to the second maximum correlation result being greater than the first threshold, the network device punctures the first traffic with the third traffic according to the second maximum correlation result and the second position index. In an embodiment of the invention, the third traffic corresponds to a third communication device. That is, the first traffic is punctured with not only the second traffic but also the third traffic (i.e., the punctured first traffic comprises partial information of the first traffic, the second traffic and the third traffic), which implies that the invention can be applied to multiple (e.g., more than two) users.

In an embodiment of the invention, the second correlation operation is known by referring the equation (1) in which T₂[n] and N₂ are replaced by T₃[n] and N₃, respectively. T₃[n] is data of the third traffic, and N₃ is a data length of the third traffic. In an embodiment of the invention, the first part of the first traffic is not considered in the second correlation operation. That is, m excludes the position index(es) of the first part of the first traffic. The second correlation operation is based on a remaining part of the first traffic. In an embodiment of the invention, the second maximum correlation result is a maximum of the plurality of second correlation results, and the second position index corresponds to the maximum of the plurality of second correlation results. In an embodiment of the invention, the step of puncturing the first traffic with the third traffic according to the second maximum correlation result and the second position index comprises: generating a weighted third traffic; and replacing a second part of the first traffic with the weighted second traffic.

In an embodiment of the invention, a start of the second part of the first traffic is indicated by the second position index. In an embodiment of the invention, the first part and the second part of the first traffic do not overlap. In an embodiment of the invention, the first part of the first traffic is blocked out after the network device punctures the first traffic with the second traffic. Accordingly, the network device does not puncture the first traffic with the third traffic on the first part of the first traffic. This is to avoid a double puncturing which leads to transmission failure of the second traffic. In an embodiment of the invention, the step of generating the weighted third traffic comprises: in response to the second maximum correlation result being greater than the second threshold, configuring that the weighted third traffic is the same as the third traffic; and in response to the second maximum correlation result being greater than the first threshold and not greater than the second threshold, performing a second weighted operation on the third traffic with the first traffic according to the second maximum correlation result and the second position index. In an embodiment of the invention, the second weighted operation is known by referring the equation (2) in which T_{2,w}[n], R[m̅], m̅, T₂[n] and N₂ are replaced by T_{3,w}[n], R′[m̅′], m̅′, T₃[n] and N₃, respectively. T_{3,w}[n] is the weighted third traffic. R′[m̅′] is the second maximum correlation result. m̅′ is the second position index. T₃[n] is data of the third traffic. N₃ is a data length of the third traffic.

In an embodiment of the invention, in response to the first maximum correlation result being not greater than the first threshold, the network device does not puncture the first traffic with the second traffic. That is, the network device processes the first traffic and the second traffic according to a conventional scheme, if the correlation of the first traffic and the second traffic is low. The conventional scheme may comprise: transmitting the first traffic and the second traffic separately at different time (e.g., WiFi5 and previous generations, but not limited herein); or combining the first traffic with the second traffic according to a communication specification (e.g., OFDMA in WiFi6 and WiFi7, but not limited herein) and transmitting the combined first traffic.

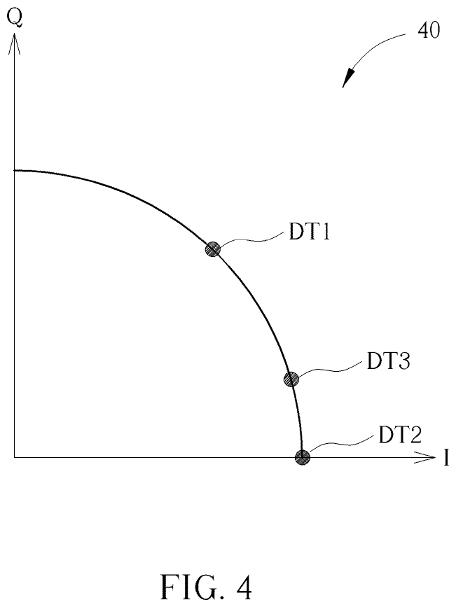

FIG. 4 is a schematic diagram of a constellation 40 according to an embodiment of the invention. In FIG. 4, an x-axis represents an imaginary part, and a y-axis represents a real part. Assuming that a normal traffic (e.g., the first traffic) comprises quadrature phase-shift keying (QPSK) data for a STA and a low latency traffic (e.g., the second traffic) comprises binary phase-shift keying (BPSK) data for other STA, there are data DT1 of the normal traffic and data DT2 of the low latency traffic in the constellation 40. Taking a weight (e.g., first maximum correlation result) with 0.6 for example, data DT3 is a weighted data (e.g., the weighted second traffic) to be punctured to the normal traffic. An AP (e.g., the network device) transmits the punctured normal traffic (i.e., transmits the data DT3 instead of the data DT1) to the STAs (e. g., the communication devices). Because the data DT3 has partial information of the data DT1 and the data DT2, the data DT3 is decoded as the data DT1 when the STA decodes the normal traffic, and the data DT3 is decoded as the data DT2 when the other STA decodes the low latency traffic. Thus, the normal traffic and the low latency traffic are successfully decoded by corresponding STAs according to the punctured normal traffic.

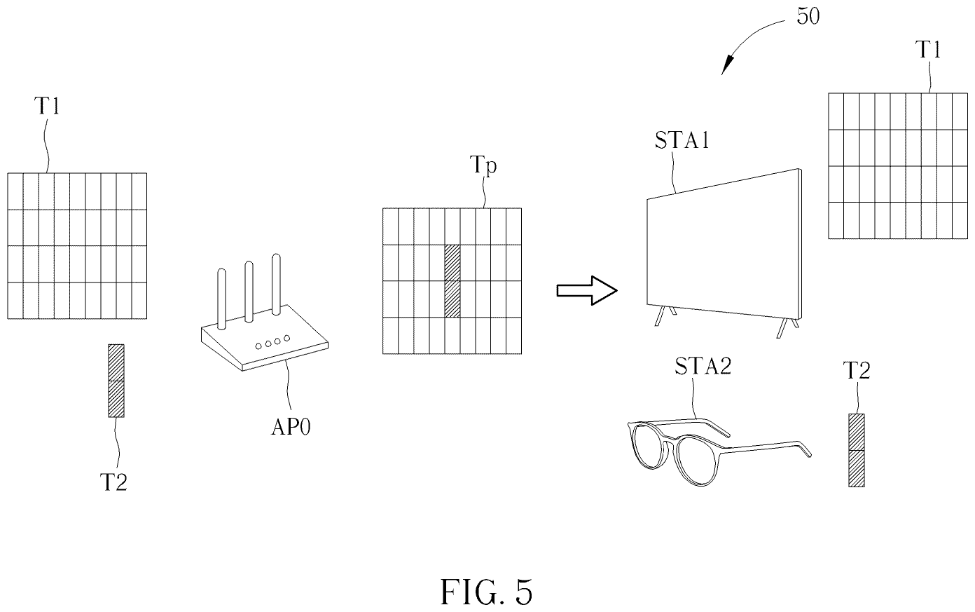

FIG. 5 is a schematic diagram of a normal puncturing mode 50 according to an embodiment of the invention. There are an AP AP0, a STA STA1 and a STA STA2 in FIG. 5. The STA STA2 is in an active mode (e.g., the STA STA2 is listening to the traffics) or a power saving mode (e.g., the STA STA2 is not listening to the traffics), and may wake up at a pre-scheduled time. The AP AP0 receives both traffics T1 and T2 before transmission, wherein the traffic T1 corresponds to the STA STA1 and the traffic T2 corresponds to the STA STA2. Accordingly, the AP AP0 has enough time to process (or schedule) the traffics T1 and T2 to generate a traffic Tp. The traffic Tp is generated by puncturing the traffic T1 with the traffic T2, which can be known by referring to the process 30 and the embodiments of the invention and is not narrated herein. The AP AP0 transmits the traffic Tp to the STAs STA1 and STA2. The STA STA1 decodes the received traffic Tp to obtain the traffic T1, and the STA STA2 decodes the received traffic Tp to obtain the traffic T2.

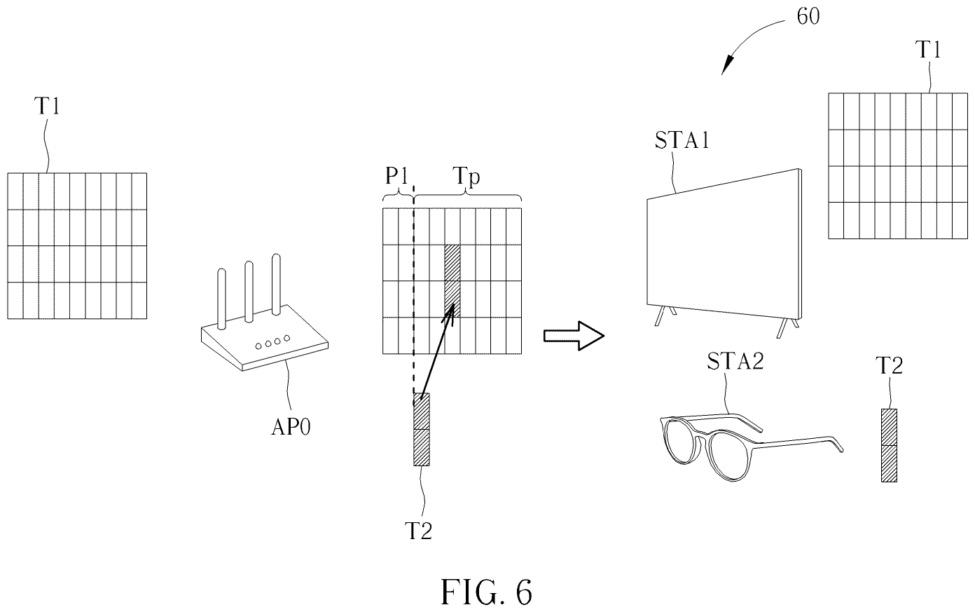

FIG. 6 is a schematic diagram of an urgent puncturing mode 60 according to an embodiment of the invention. There are an AP AP0, a STA STA1 and a STA STA2 in FIG. 6. The STA STA2 is in an active mode (e.g., the STA STA2 is listening to the traffics). The AP AP0 receives a traffic T1, and receives a traffic T2 during a transmission of the traffic T1, wherein the traffic T1 corresponds to the STA STA1 and the traffic T2 corresponds to the STA STA2. That is, the AP AP0 has been transmitted a part P1 of the traffic T1 when receiving the traffic T2. The AP AP0 processes (or schedules) the traffic T2 and a remaining part of the traffic T1 to generate a traffic Tp. In detail, the AP AP0 determines a position index for the remaining part of the traffic T1 and a maximum correlation result for the traffic T2 and the remaining part of the traffic T1. In response to the maximum correlation result being greater than the second threshold, the AP AP0 punctures the remaining part of the traffic T1 with the traffic T2 according to the position index. Then, the AP AP0 transmits the traffic Tp to the STAs STA1 and STA2. The STA STA1 decodes the received part P1 of the traffic T1 and the received traffic Tp to obtain the traffic T1, and the STA STA2 decodes the received traffic Tp to obtain the traffic T2.

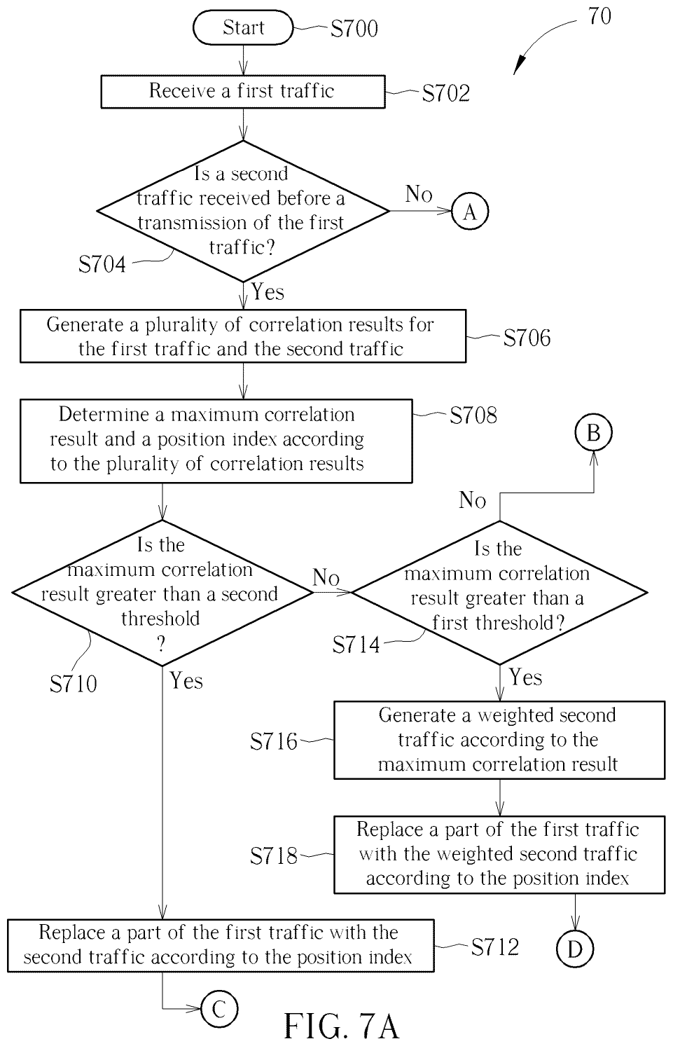

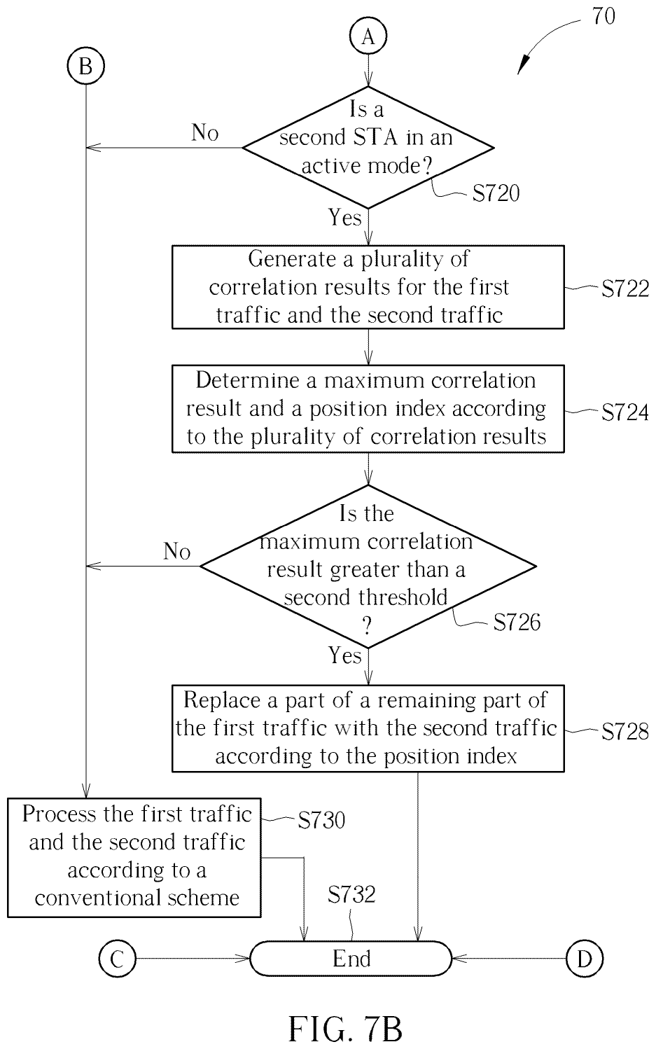

Operations of the network device (e.g., the descriptions of FIGS. 3-6 and the embodiments of the invention) can be summarized into a process 70 shown in FIGS. 7A and 7B, which processes (or schedules) a first traffic and a second traffic for the network device in order to efficiently transmit the first traffic and the second traffic to a first STA and a second STA. The process 70 includes the following steps:
Step S700: Start.
Step S702: Receive a first traffic (i.e., a normal traffic).
Step S704: Is a second traffic (i.e., a low latency traffic) received before a transmission of the first traffic? If yes, perform
Step S706. If no, perform Step S720.
Step S706: Generate a plurality of correlation results for the first traffic and the second traffic.
Step S708: Determine a maximum correlation result and a position index according to the plurality of correlation results.
Step S710: Is the maximum correlation result greater than a second threshold? If yes, perform Step S712. If no, perform Step S714.
Step S712: Replace a part of the first traffic with the second traffic according to the position index (i.e., Puncture the first traffic with the second traffic according to the position index like the normal puncturing mode 50 in FIG. 5), and perform Step S732.
Step S714: Is the maximum correlation result greater than a first threshold? If yes, perform Step S716. If no, perform Step S730.
Step S716: Generate a weighted second traffic according to the maximum correlation result.
Step S718: Replace a part of the first traffic with the weighted second traffic according to the position index (i.e., Puncture the first traffic with the weighted second traffic according to the position index like the normal puncturing mode 50 in FIG. 5), and perform Step S732.
Step S720: Is a second STA in an active mode? If yes, perform Step S722. If no, perform Step S730.
Step S722: Generate a plurality of correlation results for the first traffic and the second traffic.
Step S724: Determine a maximum correlation result and a position index according to the plurality of correlation results.
Step S726: Is the maximum correlation result greater than a second threshold? If yes, perform Step S728. If no, perform Step S730.
Step S728: Replace a part of a remaining part of the first traffic with the second traffic according to the position index (i.e., Puncture a remaining part of the first traffic with the second traffic according to the position index like the urgent puncturing mode 60 in FIG. 6), and perform Step S732.
Step S730: Process the first traffic and the second traffic according to a conventional scheme.
Step S732: End.

After the Steps S712 and S718, the network device transmits the punctured first traffic to the first STA and the second STA like the normal puncturing mode 50 in FIG. 5. After the Step S728, the network device transmits the punctured remaining part of the first traffic to the first STA and the second STA like the urgent puncturing mode 60 in FIG. 6. After the Step S730, the network device transmits the first traffic and the second traffic to the first STA and the second STA according to the conventional scheme.

In an embodiment of the invention, the first traffic and the second traffic in the process 70 are, respectively, the first traffic and the second traffic in the process 30. In an embodiment of the invention, the first traffic in the process 70 is the first traffic in the process 30, and the second traffic in the process 70 is the third traffic in the previous embodiments of the invention. In an embodiment of the invention, the first traffic in the process 70 is the punctured first traffic which comprises partial information of the first traffic and the second traffic in the process 30, and the second traffic in the process 70 is the third traffic in the previous embodiments of the invention.

Detailed descriptions and variations of the process 70 can be known by referring to the previous description, and are not narrated herein.

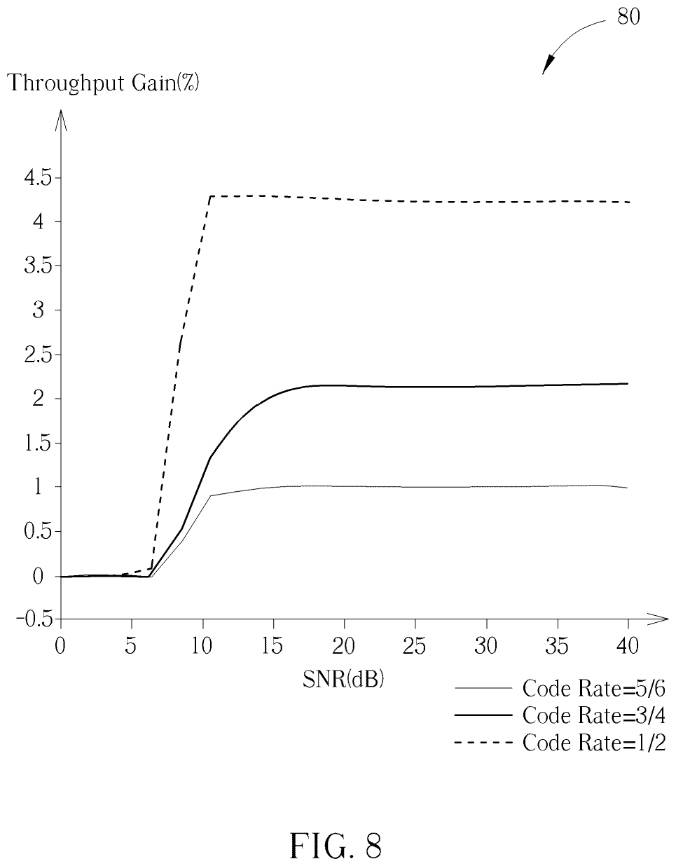

FIG. 8 is a schematic diagram of a simulation result 80 according to an embodiment of the invention. In FIG. 8, an x-axis represents an SNR (decibel (dB)) and a y-axis represents a throughput gain (%). The throughput gain may be positive or negative. The positive throughput gain means that the invention has a better throughput performance than a conventional scheme. The negative throughput gain means that the invention has a worse throughput performance than the conventional scheme. Amusing a modulation scheme with BPSK, a first threshold with 0.6, a second threshold with 0.9, a normal payload codeblock size with 648 bits and a low latency payload codeblock size with 24 bits, the simulation result 80 compares the invention for code rates ½, ¾ and ⅚ with the conventional scheme, and shows that the invention has a better throughput performance than the conventional scheme when a channel is good (e.g., SNR>8 dB).

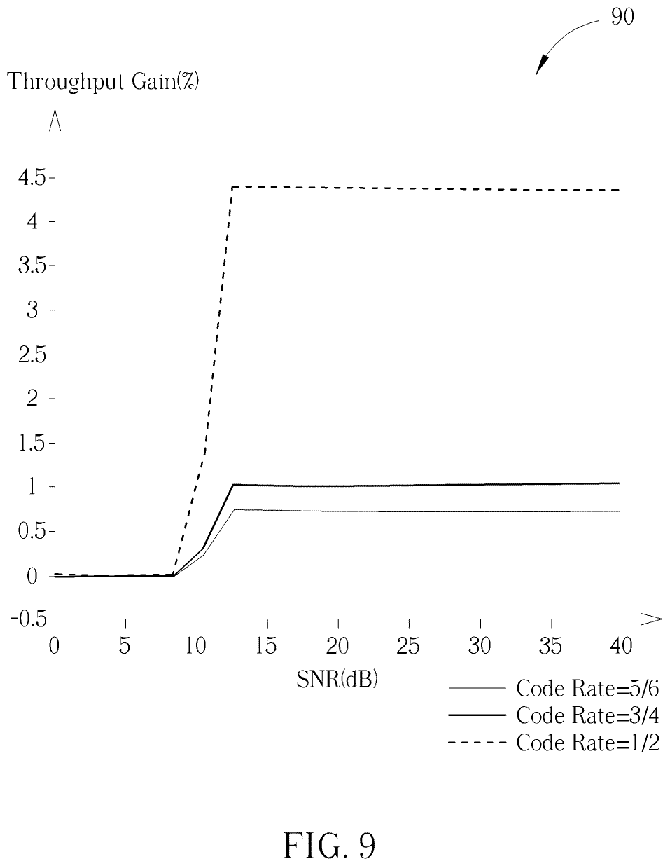

FIG. 9 is a schematic diagram of a simulation result 90 according to an embodiment of the invention. In FIG. 9, an x-axis represents an SNR (dB) and a y-axis represents a throughput gain (%). The throughput gain can be known by referring to descriptions of FIG. 8, and is not narrated herein. Amusing a modulation scheme with QPSK, a first threshold with 0.6, a second threshold with 0.9, a normal payload codeblock size with 648 bits and a low latency payload codeblock size with 24 bits, the simulation result 90 compares the invention for code rates ½, ¾ and ⅚ with the conventional scheme, and 6 shows that the invention has a better throughput performance than the conventional scheme when a channel is good (e.g., SNR>11 dB).

In FIGS. 8-9, lower modulation scheme reaches a peak throughput gain much faster than higher modulation schemes as the SNR increases.

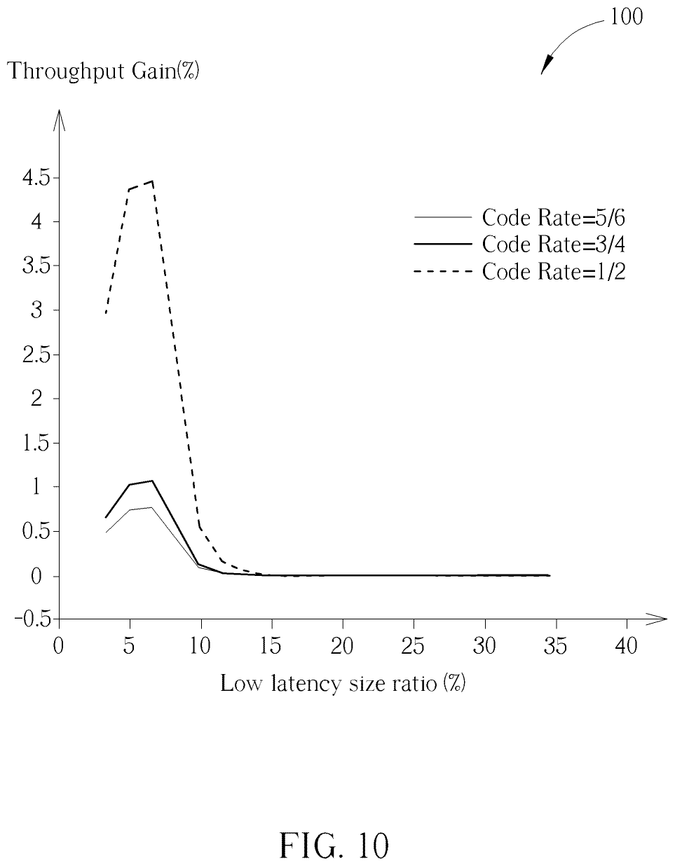

FIG. 10 is a schematic diagram of a simulation result 100 according to an embodiment of the invention. In FIG. 10, an x-axis represents a low latency size ratio (%) and a y-axis represents a throughput gain (%). The low latency size ratio is a ratio of a low latency payload codeblock size and a normal payload codeblock size. The throughput gain can be known by referring to descriptions of FIG. 8, and is not narrated herein. Amusing a modulation scheme with QPSK, a first threshold with 0.6, a second threshold with 0.9, a normal payload codeblock size with 648 bits and an SNR with 12 dB, the simulation result 100 compares the invention for code rates ½, ¾ and ⅚ with the conventional scheme, and shows that the low latency size ratio with 5% leads to a maximum throughput gain.

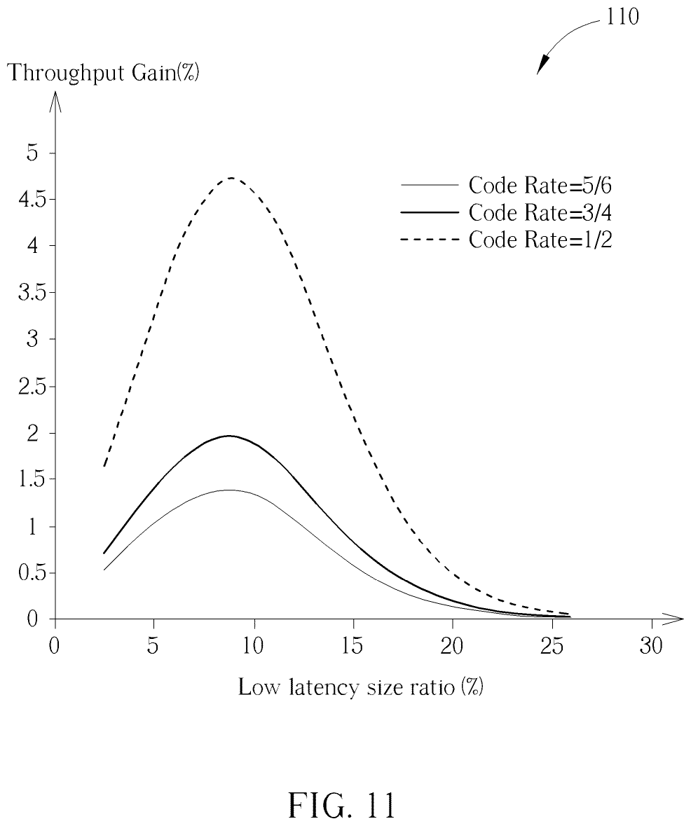

FIG. 11 is a schematic diagram of a simulation result 110 according to an embodiment of the invention. In FIG. 11, an x-axis represents a low latency size ratio (%) and a y-axis represents a throughput gain (%). The low latency size ratio and the throughput gain can be known by referring to descriptions of FIG. 10, and is not narrated herein. Amusing a modulation scheme with 256 quadrature amplitude modulation (QAM), a first threshold with 0.6, a second threshold with 0.9, a normal payload codeblock size with 648 bits and an SNR with 32 dB, the simulation result 110 compares the invention for code rates, ½, ¾ and ⅚ with the conventional scheme, and shows that the low latency size ratio with 9% leads to a maximum throughput gain.

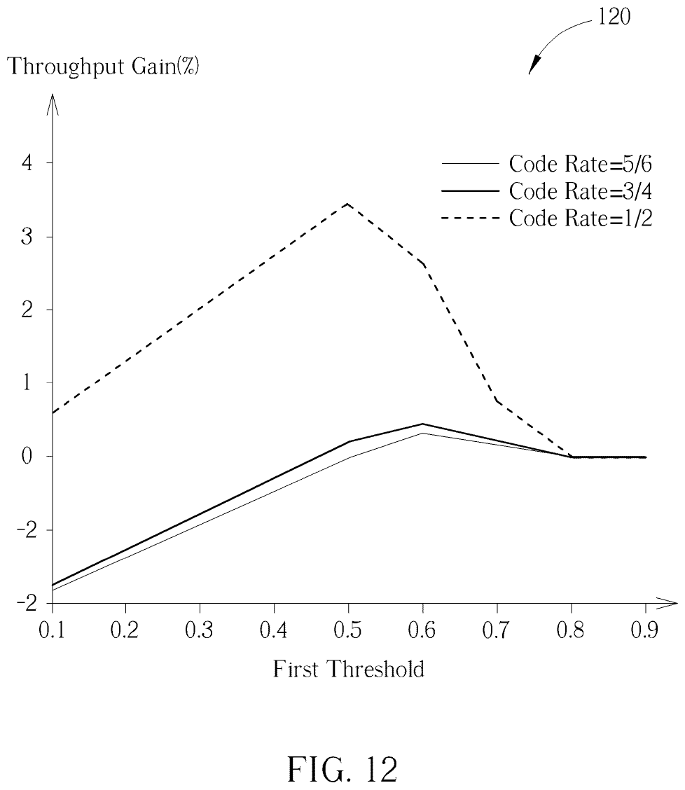

FIG. 12 is a schematic diagram of a simulation result 120 according to an embodiment of the invention. In FIG. 12, an x-axis represents a first threshold and a y-axis represents a throughput gain (%). The first threshold is smaller than a second threshold. The throughput gain can be known by referring to descriptions of FIG. 8, and is not narrated herein. Amusing a modulation scheme with BPSK, the second threshold with 0.9, a normal payload codeblock size with 648 bits, a low latency payload codeblock size with 24 bits and an SNR with 8 dB, the simulation result 120 compares the invention for code rates ½, ¾ and ⅚ with the conventional scheme, and shows that the first threshold between 0.5 and 0.6 leads to a maximum throughput gain.

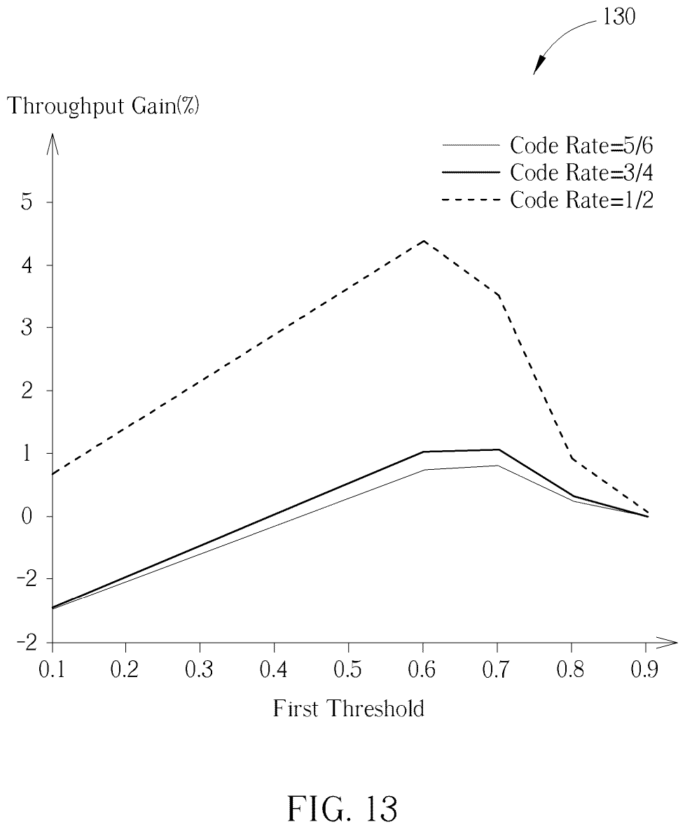

FIG. 13 is a schematic diagram of a simulation result 130 according to an embodiment of the invention. In FIG. 13, an x-axis represents a first threshold and a y-axis represents a throughput gain (%). The first threshold and the throughput gain can be known by referring to descriptions of FIG. 12, and are not narrated herein. Amusing a modulation scheme with QPSK, a second threshold with 0.9, a normal payload codeblock size with 648 bits, a low latency payload codeblock size with 24 bits and an SNR with 12 dB, the simulation result 120 compares the invention for code rates ½, ¾ and ⅚ with the conventional scheme, and shows that the first threshold between 0.6 and 0.7 leads to a maximum throughput gain.

In FIG. 8-13, a lower code rate reaches a peak throughput gain improvement much faster, because the lower code rate leads a better recovery capability to puncture errors. Higher modulation scheme supports a higher payload size but prefers a larger threshold value. In addition, there exists an optimal low latency size ratio (4%-8%) depending on modulation schemes, and there exists an optimal first threshold (0.5-0.8) depending on modulation schemes.

According to FIG. 8-13, the invention unlocks extra up to 5.3% throughput gain than a conventional scheme by simultaneously transmitting both a normal payload and a low latency payload when the channel quality is good. The invention fits both a high modulation scheme (the higher modulation scheme is easier to find a correlation position) and low modulation scheme (the lower modulation scheme is more robust to puncture errors). When the channel quality is not good, the conventional scheme is performed instead of the invention.

To sum up, the invention provides a network device and a method for handling DL multi-user multiplexing for a WLAN. The network device combines multiple traffics for multiple communication devices by puncturing a normal traffic with at least one low latency traffic, and then transmits the punctured normal traffic to the multiple communication devices. The punctured normal traffic comprises partial information of the multiple traffics. Therefore, resources (e.g., the time resource and/or the frequency resource) for transmission can be saved and the spectrum efficiency can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network device for handling downlink (DL) multi-user multiplexing for a wireless local area network (WLAN), comprising:
at least one storage device, configured to store instructions; and
at least one processing circuit, coupled to the at least one storage device and configured to execute the instructions of:
identifying a first traffic and a second traffic;
in response to the first traffic being a normal traffic and the second traffic being a low latency traffic, performing a first correlation operation according to the first traffic and the second traffic, to generate a plurality of first correlation results;
determining a first maximum correlation result and a first position index according to the plurality of first correlation results; and
in response to the first maximum correlation result being greater than a first threshold, puncturing the first traffic with the second traffic according to the first maximum correlation result and the first position index.

2. The network device of claim 1, wherein the first correlation operation is defined according to following equation:
$$R [ m ] = \frac{1}{p * {N}_{2}} {\sum }_{n = 0}^{{N}_{2} - 1} {T}_{1} [ n - m ] * {T}_{2} [ n ] , 0 \leq m \leq {N}_{1} - 1$$
wherein R[m] is a first correlation result for m, m is a variable of a position index for the first traffic, p is a normalization factor, T₁[n] and T₂[n] are data of the first traffic and the second traffic, respectively, and N₁ and N₂ are data lengths of the first traffic and the second traffic, respectively.

3. The network device of claim 1, wherein the first maximum correlation result is a maximum of the plurality of first correlation results, and the first position index corresponds to the maximum of the plurality of first correlation results.

4. The network device of claim 1, wherein the instruction of puncturing the first traffic with the second traffic according to the first maximum correlation result and the first position index comprises:
generating a weighted second traffic; and
replacing a part of the first traffic with the weighted second traffic.

5. The network device of claim 4, wherein a start of the part of the first traffic is indicated by the first position index.

6. The network device of claim 4, wherein the instruction of generating the weighted second traffic comprises:
in response to the first maximum correlation result being greater than a second threshold, configuring that the weighted second traffic is the same as the second traffic; and
in response to the first maximum correlation result being greater than the first threshold and not greater than the second threshold, performing a weighted operation on the second traffic with the first traffic according to the first maximum correlation result and the first position index.

7. The network device of claim 6, wherein the second threshold is greater than the first threshold.

8. The network device of claim 6, wherein the weighted operation is defined according to following equation:
$${T}_{2 , w} [ n ] = ( 1 - R [ \overline{m} ] ) {T}_{1} [ \overline{m} + n ] + R [ \overline{m} ] {T}_{2} [ n ] , 0 \leq n \leq {N}_{2} - 1$$
wherein T_{2,w}[n] is the weighted second traffic, R[m̅] is the first maximum correlation result, m̅ is the first position index, T₁[n] and T₂[n] are data of the first traffic and the second traffic, respectively, and N₂ is a data length of the second traffic.

9. The network device of claim 1, wherein the instructions further comprise:
adjusting the first threshold according to at least one of a channel quality, a first demodulation scheme of the first traffic and a second demodulation scheme of the second traffic.

10. The network device of claim 1, wherein the instructions further comprise:
identifying a third traffic;
in response to the first traffic being the normal traffic and the third traffic being the low latency traffic, performing a second correlation operation according to the first traffic and the third traffic, to generate a plurality of second correlation results;
determining a second maximum correlation result and a second position index according to the plurality of second correlation results; and
in response to the second maximum correlation result being greater than the first threshold, puncturing the first traffic with the third traffic according to the second maximum correlation result and the second position index.

11. A method for handling downlink (DL) multi-user multiplexing for a wireless local area network (WLAN), comprising:
identifying a first traffic and a second traffic;
in response to the first traffic being a normal traffic and the second traffic being a low latency traffic, performing a first correlation operation according to the first traffic and the second traffic, to generate a plurality of first correlation results;
determining a first maximum correlation result and a first position index according to the plurality of first correlation results; and
in response to the first maximum correlation result being greater than a first threshold, puncturing the first traffic with the second traffic according to the first maximum correlation result and the first position index.

12. The method of claim 11, wherein the first correlation operation is defined according to following equation:
$$R [ m ] = \frac{1}{p * {N}_{2}} {\sum }_{n = 0}^{{N}_{2} - 1} {T}_{1} [ n - m ] * {T}_{2} [ n ] , 0 \leq m \leq {N}_{1} - 1$$
wherein R[m] is a first correlation result for m, m is a variable of a position index for the first traffic, p is a normalization factor, T₁[n] and T₂[n] are data of the first traffic and the second traffic, respectively, and N₁ and N₂ are data lengths of the first traffic and the second traffic, respectively.

13. The method of claim 11, wherein the first maximum correlation result is a maximum of the plurality of first correlation results, and the first position index corresponds to the maximum of the plurality of first correlation results.

14. The method of claim 11, wherein the step of puncturing the first traffic with the second traffic according to the first maximum correlation result and the first position index comprises:
generating a weighted second traffic; and
replacing a part of the first traffic with the weighted second traffic.

15. The method of claim 14, wherein a start of the part of the first traffic is indicated by the first position index.

16. The method of claim 14, wherein the step of generating the weighted second traffic comprises:
in response to the first maximum correlation result being greater than a second threshold, configuring that the weighted second traffic is the same as the second traffic; and
in response to the first maximum correlation result being greater than the first threshold and not greater than the second threshold, performing a weighted operation on the second traffic with the first traffic according to the first maximum correlation result and the first position index.

17. The method of claim 16, wherein the second threshold is greater than the first threshold.

18. The method of claim 16, wherein the weighted operation is defined according to following equation:
$${T}_{2 , w} [ n ] = ( 1 - R [ \overline{m} ] ) {T}_{1} [ \overline{m} + n ] + R [ \overline{m} ] {T}_{2} [ n ] , 0 \leq n \leq {N}_{2} - 1$$
wherein T_{2,w}[n] is the weighted second traffic, R[m̅] is the first maximum correlation result, m̅ is the first position index, T₁[n] and T₂[n] are data of the first traffic and the second traffic, respectively, and N₂ is a data length of the second traffic.

19. The method of claim 11, further comprising:
adjusting the first threshold according to at least one of a channel quality, a first demodulation scheme of the first traffic and a second demodulation scheme of the second traffic.

20. The method of claim 11, further comprising:
identifying a third traffic;
in response to the first traffic being the normal traffic and the third traffic being the low latency traffic, performing a second correlation operation according to the first traffic and the third traffic, to generate a plurality of second correlation results;
determining a second maximum correlation result and a second position index according to the plurality of second correlation results; and
in response to the second maximum correlation result being greater than the first threshold, puncturing the first traffic with the third traffic according to the second maximum correlation result and the second position index.
